(19) United States
(12) Patent Application Publication
(10) Pub. No.: US 2023/0060759 A1
(43) Pub. Date: Mar. 2, 2023

(54) BOAT LIFT CONTROL SYSTEM HAVING ELECTRICALLY-INSULATED INTERFACE FOR MANUAL CONTROL OF LIFT OPERATION

(71) Applicant: Marina Electrical Equipment, Inc., Williamsburg, VA (US)

(72) Inventors: Robert C. Dively, Williamsburg, VA (US); Alston G. Brooks, Grafton, VA (US)

(21) Appl. No.: 17/813,105

(22) Filed: Jul. 18, 2022

Related U.S. Application Data
(60) Provisional application No. 63/239,651, filed on Sep. 1, 2021.

(51) Int. Cl. H01H 3/16; B63C 3/06

(52) U.S. Cl. CPC H01H 3/161; B63C 3/06

(57) ABSTRACT

A boat lift control system includes a first contactor switch and a second contactor switch. Each contactor switch, when activated, couples an AC voltage source to a boat lift motor. The first contactor switch includes a first override button. The first contactor switch is activated when the first override button is engaged. The second contactor switch includes a second override button. The second contactor switch is activated when the second override button is engaged. The first contactor switch and second contactor switch are positioned to linearly align the first override button with the second override button. An electrically non-conductive interface is adapted for user manipulation thereof resulting in engagement of the interface with one of the first override button and second override button.

Pursuant to 35 U.S.C. §119, the benefit of priority from provisional application 63/239,651, with a filing date of Sep. 1, 2021, is claimed for this non-provisional application.

### FIELD OF THE INVENTION

The invention relates generally to boat lifts, and more particularly to a boat lift control system that has an electrically-insulated user-manipulated interface configured for the safe manual control of a boat lift’s operation.

### BACKGROUND OF THE INVENTION

Motorized boat lifts are used at commercial and personal docks to raise a boat out of the water and to lower a boat into the water. Similar to motorized garage door openers, boat lifts typically are operated by a control system frequently referred to in the art as “boat lift remote controls” or “boat lift switches”. Regardless of its name, a boat lift control system typically has one or two momentary-touch buttons that start a boat lift raising operation or a boat lift lowering operation. That is, once one of these operations is commenced, the raising or lowering operation must be fully completed before the opposite operation can be commenced. However, there may be times when it is desired to have a boat lift stop somewhere between its fully raised or fully lowered position. Currently, this can only be accomplished by engaging an “emergency stop” control or accessing the electronics within the boat lift control system.

### SUMMARY OF THE INVENTION

Accordingly, it is an object of the present invention to provide a boat lift control system.

Another object of the present invention is to provide a boat lift control system that allows a user to manually control a boat lift’s raising and lowering operation.

Still another object of the present invention is to provide a simple, user-accessible and electrically-insulated control interface for the safe manual control of a boat lift’s raising and lowering operations.

Other objects and advantages of the present invention will become more obvious hereinafter in the specification and drawings.

In accordance with the present invention, a boat lift control system includes a first contactor switch adapted to couple an AC voltage source to a boat lift motor when the first contactor switch is activated. The first contactor switch includes a first override button. The first contactor switch is activated when the first override button is engaged. The boat lift control system also includes a second contactor switch adapted to couple the AC voltage source to the boat lift motor when the second contactor switch is activated. The second contactor switch includes a second override button. The second contactor switch is activated when the second override button is engaged. The first contactor switch and second contactor switch are positioned to linearly align the first override button with the second override button. An electrically non-conductive interface is adapted for user manipulation thereof resulting in engagement of the interface with one of the first override button and second override button.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of a boat lift control system equipped with a manually-operated, raising/lowering interface in accordance with an embodiment of the present invention;

FIG. 2 is an isolated side view of a base portion of a manual interface in accordance with an embodiment of the present invention;

FIG. 3 is a top view of the base taken along line 3-3 in FIG. 2;

FIG. 4 is a side view of the base taken along line 4-4 in FIG. 2;

FIG. 5 is an isolated plan view of a balanced Y-shaped control arm in accordance with an embodiment of the present invention;

FIG. 6 is a side view of the control arm and base mounted to the adjacently-positioned up contactor and down contactor of a boat lift control system in accordance with an embodiment of the present invention; and

FIG. 7 is a plan view of the control arm and base taken along line 7-7 in FIG. 6 illustrating alignment of the control arm over the adjacently-positioned up contactor and down contactor.

### DETAILED DESCRIPTION OF THE INVENTION

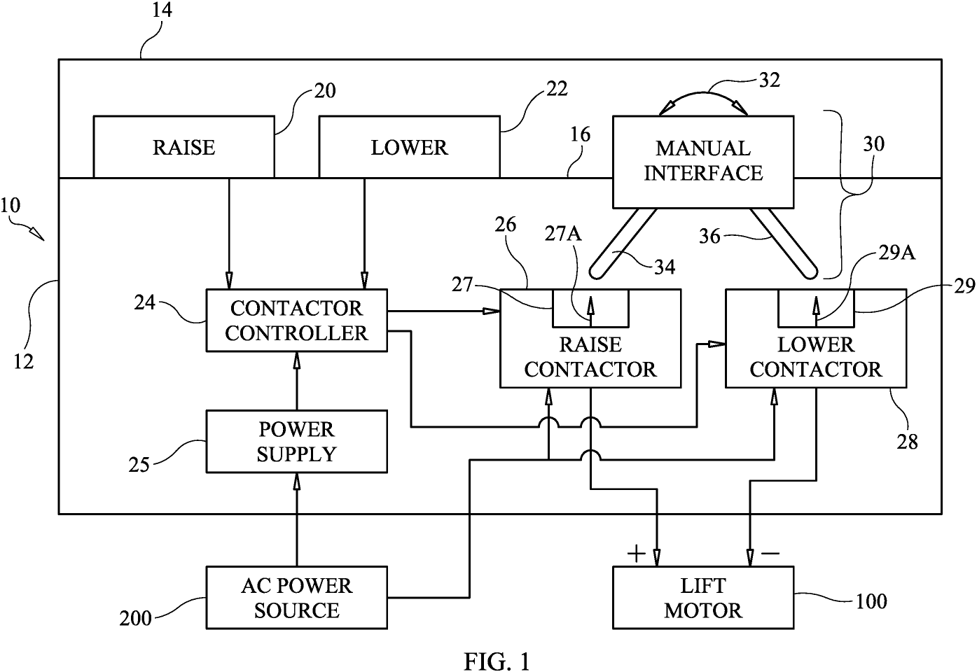

Referring now to the drawings and more particularly to FIG. 1, a boat lift control system equipped with a manually-operated raising and lowering interface in accordance with an embodiment of the present invention is shown and is referenced generally by numeral 10. Boat lift control system 10 controls the coupling of a power source to a lift motor 100 that is used to raise or lower a boat lift (not shown). By way of convention, lift motor 100 is powered to raise a boat lift when supplied with “+” polarity power or is powered to lower a boat lift when supplied with the opposite or “-” polarity power as is understood in the art. The type, size, etc., of lift motor 100 is not a limitation of the present invention. Power for lift motor 100 is supplied by an AC power source 200 routed through control system 10 to boat lift motor 100 as will be explained further below.

Boat lift control system 10 typically includes a rigid housing 12 configured for mounting at a dock location having a boat lift installed thereat. In some embodiments of the present invention, control system 10 includes a removable cover 14 to provide weather protection for portions of control system 10 that a user will access at an exterior face 16 of housing 12. Cover 14 can be completely removable from housing 14 or coupled thereto (e.g., via hinges, a tether, etc.) without departing from the scope of the present invention.

Boat lift control system 10 also includes a momentary-touch button 20 for initiating a boat lift raising operation via lift motor 100, and a momentary-touch button 22 for initiating a boat lift lowering operation via lift motor 100. Each of buttons 20 and 22 is a touch-and-release or press-and-release button accessible at exterior face 16 of housing 12. A variety of such buttons are well known in the art. A contactor controller 24 mounted in housing 12 is coupled to buttons 20 and 22, and is configured to output a control signal to one of a raising contactor switch 26 (referred to hereinafter as “raise contactor”) or to a lowering contactor switch 26 (referred to hereinafter as “lower contactor”) depending on which of buttons 20 or 22 is touched/pressed. Raise contactor 26 and lower contactor 28 are mounted in housing 12.

When raise button 20 is engaged, controller 24 outputs a control signal that closes an internal switch (not shown) of raise contactor 26 thereby activating raise contactor 26 so that AC power from source 200 is coupled to lift motor 100 through raise contactor 26 to initiate a boat lift’s raising operation. When lower button 22 is engaged, controller 24 outputs a control signal that closes an internal switch (not shown) of lower contactor 28 thereby activating lower contactor 28 so that AC power from source 200 is coupled to lift motor 100 through lower contactor 28 to initiate a boat lift’s lowering operation. In each case, the raising and lowering operations only cease when a boat lift reaches pre-programmed upper and lower end limits of its respective upward or downward travel. In general, a boat lift is capable of upward and downward amounts of movement that exceed what is defined by the pre-programmed upper and lower end limits. Indeed, there are many times that a boat needs to be raised above its pre-programmed upper end limit (e.g., high water times, boat maintenance operations, etc.) or lower end limit (e.g., extreme low tides, etc.). As will be explained further below, the present invention provides for safe operation of a boat lift control in any manual operation situation to include those requiring boat lift movement beyond its pre-programmed upper and lower end limits.

The use of contactors 26 and 28 allows a low-power controller 24 to be used even though lift motor 100 requires a much higher power level such as that delivered by AC power source 200. For example and in a typical installation, AC power source 200 can be a 240 volt AC source needed to power lift motor 100, while controller 24 requires a much smaller voltage (e.g., on the order of 24 volts) provided by a power supply 25 electrically coupled between AC power source 200 and controller 24 as would be understood in the art.

Each of contactors 26 and 28 has a respective manual override button 27 and 29. When depressed, each of buttons 27 and 29 activates the respective contactor by controlling the opening/closing of the contactor’s internal switch. Each of buttons 27 and 29 is spring-biased (as indicated by respective arrows 27A and 29A) to thereby bias the contactor’s internal switch to an open or non-conducting position when the button is not depressed with a force that exceeds its spring bias. That is, each contactor’s internal switch remains open (i.e., no power from source 200 is supplied to lift motor 100) unless the contactor is activated by either receipt of a control signal from controller 24 as described above or by its override button being depressed by a force that exceeds the spring bias of the override button. A variety of contactor switches configured to operate in this fashion are available commercially as would be understood by one of ordinary skill in the art. In some embodiments of the present invention, contactor switches are identical types/models of contactor switches.

As long as either of override buttons 27 or 29 is depressed such that its spring bias is exceeded, the respective contactor’s internal switch remains closed such that the high-voltage AC power source 200 is coupled to lift motor 100. Accordingly, a lift raising operation can be maintained as long as button 27 is depressed, or a lift lowering operation can be maintained as long as button 29 is depressed.

Since a raising of a boat lift (via engagement of raise button 20) or a lowering of a boat lift (via engagement of lower button 22) in accordance with the above-described upper and lower end limits is not always desired, the present invention provides a simple and safe user-accessible interface that allows a user to readily engage one of manual override buttons 27 and 29 on respective contactors 26 and 28 without risk of any exposure to the high-voltage AC power source 200. This is achieved in the present invention by the provisional of an electrically non-conductive manual interface 30 in combination with adjacently-positioned contactors 26 and 28 as will be explained further below. A portion of manual interface 30 is user accessible from the exterior face 16 of housing 12. Manual interface 30 is configured for manual manipulation as indicated by two-headed arrow 32 to depress either override button 27 or 29 for a user-defined period of time such that motor 100 is operated manually in one of a raising or lowering operation. In some embodiments of the present invention, manual interface 30 includes two legs 34 and 36 for depressing one of buttons 27 or 29, respectively, based on user manipulation 32. As soon as user manipulation 32 is removed or ceases, the spring bias 27A or 29A is restored and acts to respectively push leg 34 or leg 36 away from button 27 or 29, respectively.

Since both contactors 26 and 28 are connected to high-voltage AC power source 200 (e.g., a 240-volt source), it is critical that the user-accessed manual interface 30 is electrically isolated from AC power source 200. Note that this is not a problem with buttons 20 and 22 as they are connected to contactor controller 24 that receives a much lower voltage from power supply 25 as explained previously herein.

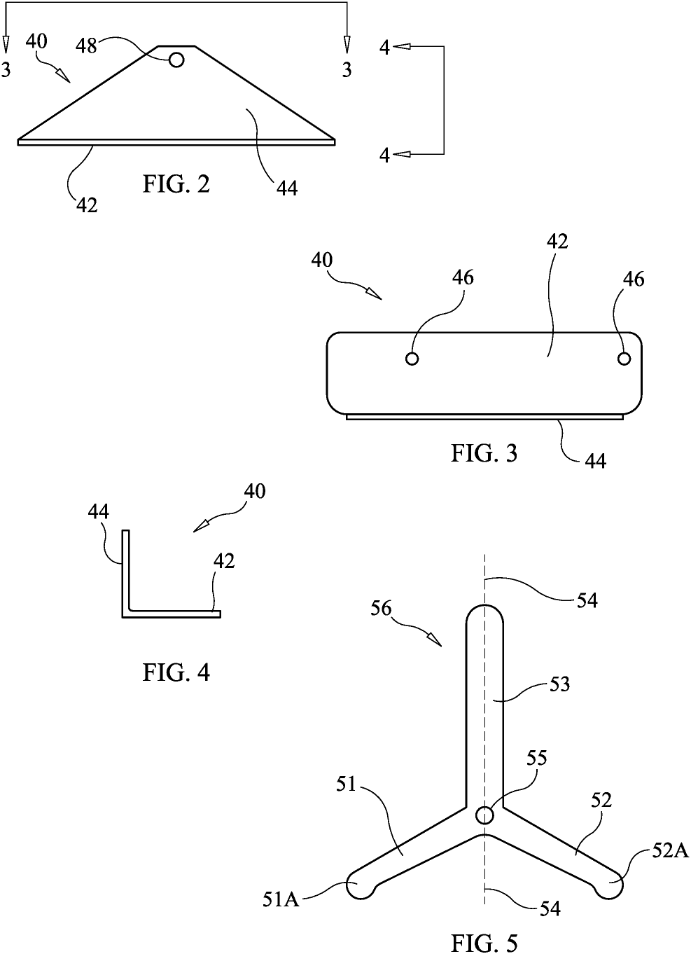

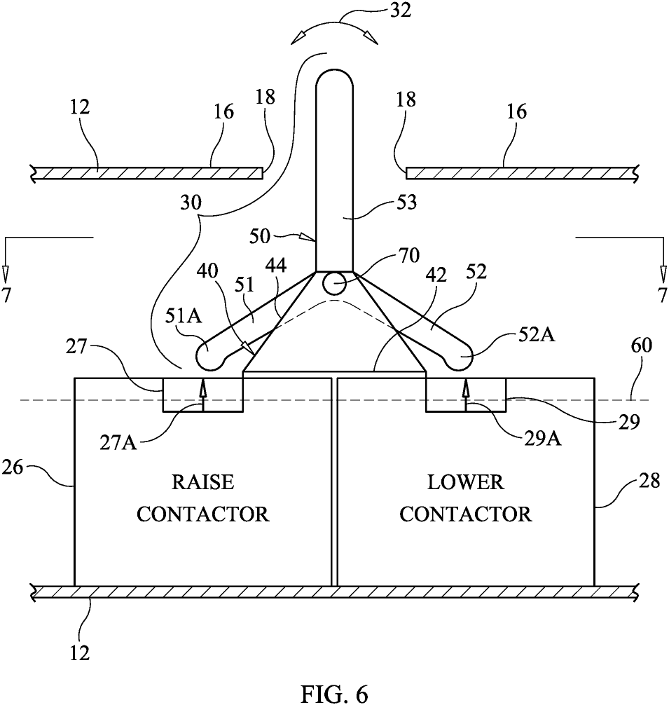

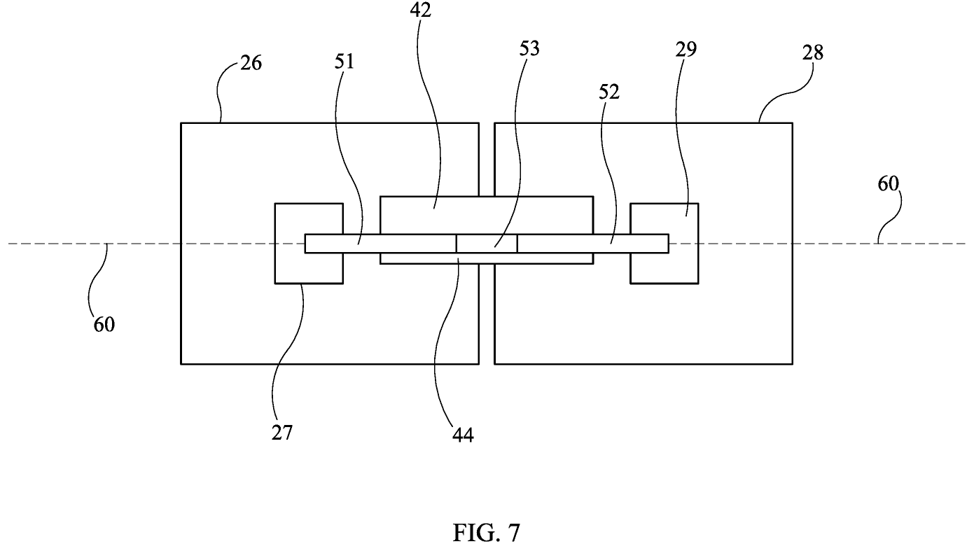

An exemplary embodiment of manual interface 30 will now be described with simultaneous reference to FIGS. 2-7. Briefly, FIGS. 2-5 illustrate portions of the interface assembly in isolation. FIGS. 6-7 illustrate an embodiment of manual interface 30 mounted to adjacently-positioned contactors 26 and 28 within housing 12. Contactors 26 and 28 are positioned to have their respective override buttons 27 and 29 linearly aligned with one another and in the same plane as indicated by dashed line 60. Contactors 26 and 28 can be identical contactor switches that are electrically coupled to one another in a ganged configuration to support the application of respective raising (“+”) or lowering (“-”) polarity voltages to lift motor 100. Electrical coupling of contactors 26 and 28 in such a ganged configuration would be understood by one of ordinary skill in the art.

Manual interface 30 includes a base 40 (FIGS. 2-4) and an inverted Y-shaped control arm 50 (FIG. 5). Base 40 and control arm 50 are made from any electrically non-conductive material (e.g., plastic, composite, etc.) that is typically rigid. In the illustrated embodiment, base 40 is generally L-shaped (as best seen in FIG. 4), and has a foot plate 42 and an arm-mounting plate 44. Foot plate 42 has screw holes 46 and arm-mounting plate 44 has a hole (or slot) 48 used for the hinged coupling of control arm 50 to base 40. It is to be understood that other shapes and configurations of the base can be used without departing from the scope of the present invention. For example and in some embodiments of the present invention, the base can be configured to snap into existing holes in the body of a contactor. It is further to be understood that the control arm can be configured in other ways without departing from the scope of the present invention.

In the illustrated embodiment, control arm 50 is a solid one-piece, three-leg structure configured in a Y-shape that lies in a common plane. More specifically, control arm 50 has identical legs 51 and 52 coupled to or integrated with a common leg 53, all of which lie in the same plane. Control arm 50 is weight balanced relative to its central longitudinal axis referenced by dashed line 54. That is, half of the weight of control arm 50 is attributed to leg 52 and half of leg 53, and the other half of the weight of control arm 50 is attributed to leg 52 and the other half of leg 53. A hole 55 is provided along axis 54 where legs 51/52 integrate with leg 53. In use, control arm 50 is inverted and hingedly coupled to base 40 by a pinning fastener 70 (FIG. 6) such as a bolt, rivet, etc., that passes through aligned holes 48 and 55.

As mentioned above, raise contactor 26 and lower contactor 28 are positioned adjacent to one another in housing 12 with buttons 27 and 29 facing user-accessible face 16 of housing 12 and linearly aligned in the same plane along line 60 as illustrated in FIGS. 6 and 7. Foot plate 42 is mounted to contactors 26/28 using, for example, screw holes 46 that can be positioned to use screws (not shown) typically available at the face of commercially-available contactors. Base 40 is configured to position control arm 50 such its defined plane is perpendicular to the plane in which override buttons 27 and 29 reside.

Control arm 50 is sized so that its leg 53 extends out of an opening 18 in user-accessible face 16 thereby making a portion of leg 53 accessible for manipulation by a user. Opening 18 is sized to permit user manipulation 32 of control arm 50 (e.g., rotation of control arm 50 in its common plane). Manual interface 30 is configured and positioned such that the plane defined by control arm 50 is aligned with line 60 that defines the alignment of buttons 27 and 29, and such that outboard tips 51A/52A of legs 51/52 are aligned over override buttons 27/29. In other words, the pivot point of control arm 50 defined by pinning fastener 70 is halfway between buttons 27 and 29. In this way, when raise contactor 26 is to be manually engaged, leg 53 is manipulated/rotated in one direction so that outboard tip 51A of leg 51 depresses button 27 against spring bias 27A. Conversely, when lower contactor 28 is to be manually engaged, leg 53 is manipulated/rotated in the opposite direction so that outboard tip 52A of leg 52 depresses button 29 against spring bias 29A. When no user-manipulation 32 is applied to leg 53, spring forces 27A and 29A act in concert with the weight-balanced control arm 50 to return control arm 50 to a neutral position where neither contactor 26 or 28 is manually engaged.

The advantages of the present invention are numerous. The boat lift control system provides for both one-touch, complete-cycle boat lift raising/lowering operations, but also provides for manual control of the raising/lowering operations. Under manual control, a boat can be raised or lowered beyond the boat lift control’s pre-programmed upper and lower end limits in accordance with a user’s needs. The position of the control system’s contactors in combination with the electrically-insulated manual interface provides a simple and electrically safe solution for the manual control of motorized boat lifts.

Although the invention has been described relative to specific embodiments thereof, there are numerous variations and modifications that will be readily apparent to those skilled in the art in light of the above teachings. For example and in some embodiments of the present invention, activation of either manual override button 27 or 29 could be used by contact controller 24 to render momentary-touch buttons 20 and 22 inactive during the time that either one of override buttons 27 and 29 is activated. It is therefore to be understood that, within the scope of the appended claims, the invention may be practiced other than as specifically described.

What is claimed as new and desired to be secured by letters patent of the united states is:

1. A boat lift control system, comprising:
a first contactor switch adapted to couple an AC voltage source to a boat lift motor when said first contactor switch is activated, said first contactor switch including a first override button wherein said first contactor switch is activated when said first override button is engaged;
a second contactor switch adapted to couple the AC voltage source to the boat lift motor when said second contactor switch is activated, said second contactor switch including a second override button wherein said second contactor switch is activated when said second override button is engaged;
said first contactor switch and said second contactor switch positioned to linearly align said first override button with said second override button; and
an electrically non-conductive interface adapted for user manipulation thereof and resulting engagement thereof with one of said first override button and said second override button.

2. A boat lift control system as in claim 1, wherein said electrically non-conductive interface comprises:
a base coupled to said first contactor switch and said second contactor switch; and
a one-piece control arm made from an electrically non-conductive material, said control arm movably coupled to said base and adapted to be moved relative to said base by the user manipulation.

3. A boat lift control system as in claim 2, wherein said control arm is Y-shaped.

4. A boat lift control system as in claim 2, wherein said control arm lies in a plane aligned with said first contactor switch and said second contactor switch, wherein said control arm is hingedly coupled to said base at a position that is halfway between said first override button and said second override button, and wherein the user manipulation rotates said control arm in said plane.

5. A boat lift control system as in claim 1,
wherein said first contactor switch is electrically coupled to said second contactor switch,
wherein, when activated, said first contactor switch provides an AC voltage having a first polarity from the AC power source to the boat lift motor,
wherein, when activated, said second contactor switch provides an AC voltage having a second polarity from the AC power source to the boat lift motor, and
wherein said first polarity and said second polarity are opposing polarities.

6. A boat lift control system as in clam 2, wherein said control arm comprises:
a first leg for engagement with said first override button when said control arm is moved in a first direction; and
a second leg for engagement with said second override button when said control arm is moved in a second direction.

7. A boat lift control system, comprising:
a first contactor switch adapted to couple an AC voltage source to a boat lift motor when said first contactor switch is activated, said first contactor switch including a first override button having a first spring bias wherein said first contactor switch is activated when said first spring bias is exceeded;
a second contactor switch adapted to couple the AC voltage source to the boat lift motor when said second contactor switch is activated, said second contactor switch including a second override button having a second spring bias wherein said second contactor switch is activated when said second spring bias is exceeded;
said first contactor switch and said second contactor switch positioned to linearly align said first override button with said second override button; and
an interface coupled to said first contactor switch and said second contactor switch, said interface adapted for user manipulation and corresponding engagement with one of said first override button and said second override button to exceed a corresponding one of said first spring bias and said second spring bias, wherein cessation of the user manipulation restores said corresponding one of said first spring bias and said second spring bias.

8. A boat lift control system as in claim 7, wherein said interface comprises:
a base coupled to said first contactor switch and said second contactor switch; and
a one-piece control arm made from an electrically non-conductive material, said control arm movably coupled to said base and adapted to be moved relative to said base for engagement with one of said first override button and said second override button.

9. A boat lift control system as in claim 8, wherein said control arm is Y-shaped.

10. A boat lift control system as in claim 8, wherein said control arm lies in a plane aligned with said first contactor switch and said second contactor switch, wherein said control arm is hingedly coupled to said base at a position that is halfway between said first override button and said second override button, and wherein the user manipulation rotates said control arm in said plane.

11. A boat lift control system as in claim 7,
wherein said first contactor switch is electrically coupled to said second contactor switch,
wherein, when activated, said first contactor switch provides an AC voltage having a first polarity from the AC power source to the boat lift motor,
wherein, when activated, said second contactor switch provides an AC voltage having a second polarity from the AC power source to the boat lift motor, and
wherein said first polarity and said second polarity are opposing polarities.

12. A boat lift control system as in clam 8, wherein said control arm comprises:
a first leg for engagement with said first override button when said control arm is moved in a first direction; and
a second leg for engagement with said second override button when said control arm is moved in a second direction.

13. A boat lift control system, comprising:
a controller for generating one of a first control signal and a second control signal;
a first contactor switch coupled to said controller and adapted to couple an AC voltage source to a boat lift motor when said first contactor switch is activated, said first contactor switch including a first override button, wherein said first contactor switch is activated by one of said first control signal and engagement of said first override button;
a second contactor switch coupled to said controller and adapted to couple the AC voltage source to the boat lift motor when said second contactor switch is activated, said second contactor switch including a second override button, wherein said second contactor switch is activated by one of said second control signal and engagement of said second override button;
said first contactor switch and said second contactor switch positioned to linearly align said first override button with said second override button in a common plane; and
an interface adapted for user manipulation thereof and resulting engagement thereof with one of said first override button and said second override button.

14. A boat lift control system as in claim 13, wherein said interface comprises:
a base coupled to said first contactor switch and said second contactor switch; and
a one-piece control arm made from an electrically non-conductive material, said control arm movably coupled to said base and adapted to be moved relative to said base by the user manipulation.

15. A boat lift control system as in claim 14, wherein said control arm is Y-shaped.

16. A boat lift control system as in claim 14, wherein said control arm lies in a plane aligned with said first contactor switch and said second contactor switch, wherein said plane is perpendicular to said common plane, wherein said control arm is hingedly coupled to said base at a position that is halfway between said first override button and said second override button, and wherein the user manipulation rotates said control arm in said plane.

17. A boat lift control system as in claim 13,
wherein said first contactor switch is electrically coupled to said second contactor switch,
wherein, when activated, said first contactor switch provides an AC voltage having a first polarity from the AC power source to the boat lift motor,
wherein, when activated, said second contactor switch provides an AC voltage having a second polarity from the AC power source to the boat lift motor, and
wherein said first polarity and said second polarity are opposing polarities.

18. A boat lift control system as in clam 14, wherein said control arm comprises:
a first leg for engagement with said first override button when said control arm is moved in a first direction; and
a second leg for engagement with said second override button when said control arm is moved in a second direction.
